(19) United States
(12) Patent Application Publication
(10) Pub. No.: US 2016/0232296 A1
(43) Pub. Date: Aug. 11, 2016

(54) A COMPUTING DEVICE-IMPLEMENTED METHOD FOR MANAGING HEALTH FILE

(71) Applicant: HELLO DOCTOR LTD., Tel Aviv (IL)

(72) Inventors: Maayan COHEN, PALO ALTO, CA (US); Ziv MELTZER, TEL AVIV (IL); Eran Mordechai KEISAR, RAMAT GAN (IL)

(73) Assignee: HELLO DOCTOR LTD., TEL AVIV (IL)

(21) Appl. No.: 15/024,092

(22) PCT Filed: Aug. 6, 2014
(86) PCT No.: PCT/IL14/50711

§ 371 Date: Mar. 23, 2016

Related U.S. Application Data
(60) Provisional application No. 61/881,963, filed on Sep. 25, 2013.

(51) Int. Cl. G06F 19/00

(52) U.S. Cl. CPC G06F 19/321

(57) ABSTRACT

The present invention provides a computing device-implemented method for managing medical health record comprising the steps of: i. acquiring at least one computing device; ii. installing an application implementing said method; iii. establishing a client's health file; iv. managing said client's said health file; v. analyzing said client's said health file; vi. establishing at least one support group; wherein said step of establishing said client's said health file comprises means selected from the group consisting of inputting at least one medical digital document, inputting a digital copy of at least one hardcopy medical document.

### BACKGROUND OF THE PRESENT INVENTION

People suffering from chronic medical conditions or having an acute disease such as cancer have to perform different medical tests, undergo many treatments and consult more than one specialist. Usually medical facilities where patients undergo their treatments and make tests are geographically scattered. Moreover, these facilities may belong to different organizations and thus do not share common database. Furthermore, gravely ill people tend to go to as many specialists as they can afford. This type of patients can receive contradicting prescription drugs from several physicians because there are specialists that do not bother themselves to ask patients for additional information. These specialists usually have a privet practice and do not connected electronically to any network.

Thus patients after a round of tests, treatments and visiting privet clinicians remain with a pile of medical documents both in an electronic form and in a hardcopy form. Many times people print out their electronic records and organize their physicians' handouts in a big ring binder and carry it with them every time they go to a medical facility. Thereby they risk losing valuable data and exposing confidential information. Often people cannot decipher their tests or understand clinicians' handouts and have to spend many hours surfing the Internet in attempt to elucidate clinician's notes and get information about prescription drugs and their side effects. Moreover, a patient suffering from a serious medical condition wishes to connect to the people with the same condition and ask their advice. Thus there is a strong felt and unmet need to provide a computing device-implemented method for managing medical records.

### SUMMARY OF THE PRESENT INVENTION

It is a purpose of the present invention to provide a computing device-implemented method for managing medical health record comprising the steps of: i) acquiring at least one computing device, ii) installing an application implementing the method, iii) establishing a client's health file, iv) managing the client's the health file, v) analyzing the client's the health file, vi) establishing at least one support group, wherein the step of establishing the client's the health file comprises means selected from the group consisting of inputting at least one medical digital document and inputting a digital copy of at least one hardcopy medical document.

The method as described above, wherein the at least one computing device is selected from the group consisting of mobile phone, smartphone, tablet computer, wearable computer, calculator watch, smartwatch, head-mounted display, personal digital assistant, enterprise digital assistant, calculator, handheld game console, portable media player, ultra-mobile PC, digital still camera (DSC), digital video camera (DVC), digital camcorder, feature phone, pager, personal navigation device, desktop computer, laptop computer.

The method as described above, wherein the step of establishing a health file additionally comprises uploading at least one medical imaging document selected from the group consisting of-ray, MRI, fluoroscopy, scintigraphy, SPECT, PET, CT-PET, PET/MRI, ultra-sound, tactile imaging, photoacoustic imaging, thermography, tomography, echocardiography.

The method as described above, wherein the method additionally comprises connecting the computing device to the Internet.

The method as described above, wherein the method additionally comprises connecting the computing device to a local network or Intranet.

The method as described above, wherein the method additionally configured to be implemented offline.

The method as described above, wherein the step of establishing a health file additionally comprises automatic tagging of at least one input medical document.

The method as described above, wherein the step of establishing a health file additionally comprises manual tagging by the client of at least one input medical document.

The method as described above, wherein the step of establishing a health file includes configuring the computing device to use a camera application for importing the digital copy of the hardcopy medical document.

The method as described above, wherein the establishing step of a health file is configured to use a scanning device for importing the digital copy of at least one hardcopy medical document.

The method as described above, wherein the establishing step of a health file is additionally configured to download at least one digital medical document from at least one online server.

The method as described above, wherein the importing step additionally comprises a step of document edges detection.

The method as described above, wherein the importing step additionally comprises text recognition configured to recognize a type, and a date of the input document.

The method as described above, wherein the importing step additionally comprises optical character recognition of the photographed hardcopy document.

The method as described above, wherein the establishing step additionally comprises importing medical data from a HL7 enabled organization.

The method as described above, wherein the establishing step additionally comprises using Blue Button.

The method as described above, wherein the establishing step additionally comprises importing medical data from an EMR Patient Portal by the user himself

The method as described above, wherein the establishing step additionally comprises importing medical data from the EMR Patient Portal automatically.

The method as described above, wherein the establishing step additionally comprises sending a notification to the user to keep the medical file up-to-date.

The method as described above, wherein the notification can be selected from the group consisting of an e-mail, SMS, a sound effect, a popping window.

The method as described above, wherein the notification can be triggered by means selected from the group consisting of location, time, a periodic reminder.

The method as described above, wherein the establishing step additionally comprises inputting self-generated data.

The method as described above, wherein the step of inputting self-generated data comprises data from official records, unofficial records, self-monitoring devices, self-reported data, Non-medical data, wellness data, mobility data, Wong Baker pain scale data, Numeric Rating Scale, ECOG/WHO/Zubrod score, Karnofsky scale, Apgar scale for newborns and any other conventional scale.

The method as described above, wherein the step of inputting self-generated data comprises importing data from self-monitoring devices selected from the group consisting of a heart rate monitor watch, pedometer, glucometer, sphygmometer and any other known in the art device.

The method as described above, wherein the step of inputting self-generated data comprises inputting questions to the physicians, fears concerning treatment options, diagnosis, medications' doses and side effects.

The method as described above, wherein the step of inputting self-generated data comprises adding information regarding the user's the lifestyle habits and conditions selected from the group consisting of nutritional habits, sleeping hours, sleeping patterns type of physical exercise the user practices, stressful situations the user goes through, substance abuse, the user's psychological status and any other lifestyle habits.

The method as described above, wherein the managing step is additionally configured to present the file in a chronological order.

The method as described above, wherein the medical document is configured to be tagged with a Record Type and a Record Date.

The method as described above, wherein the managing step additionally comprises diary managing.

The method as described above, wherein the diary management additionally comprise reminding means configure to be selected from the group consisting of popping windows, sound alarm, e-mailing, sending an SMS.

The method as described above, wherein the diary management additionally comprises monitoring at least one periodic behavioral pattern adherence.

The method as described above, wherein the diary management is configured to create at least one adherent report of the pattern.

The method as described above, wherein the establishing step configured to allow the user to input at least one page per the document.

The method as described above, wherein the managing step additionally comprises establishing metadata.

The method as described above, wherein the managing step additionally comprises searching through the file by means selected from the group consisting of text-based search engine and implementing timestamps.

The method as described above, wherein the method additionally comprises a graphical user interface (GUI).

The method as described above, wherein the method additionally comprises a Smartlist document navigation method.

The method as described above, wherein the managing step is additionally configured to share the health record by a route selected from the group consisting of e-mail, a mobile ad hoc network, wireless ad hoc network, electronic patient record, exporting to online cloud storage, fax, sharing direct link, using Direct, copying to the mobile device's clipboard.

The method as described above, wherein the managing step is additionally configured to generate at least one data report.

The method as described above, wherein the managing step is additionally configured to present the medical data by at least one data management chart.

The method as described above, wherein the managing step is additionally configured to create automatically a timeline chart.

The method as described above, wherein the managing step is additionally configured to allow the user to create manually the timeline chart.

The method as described above, wherein the managing step is additionally configured to allow the user to create a customized view of the medical file.

The method as described above, wherein the managing step is additionally enables the user to add a question or a comment to a specific document relating to the content of the document.

The method as described above, wherein the analyzing step comprises creating a digital dashboard.

The method as described above, wherein the analyzing step comprises a statistical analysis of the self-generated data and presenting the analysis as grouped data.

The method as described above, wherein the analyzing step additionally comprises presenting to the user at least one relevant recent medical research or at least one article, and supplying easy access to at least one medical research or at least one article, highlighting relevant and important information from at least one medical research or at least one article in an everyday language.

The method as described above, wherein the analyzing step additionally comprises showing the client what medical treatment other users chose being in the client's medical condition and demographic group.

The method as described above, wherein the analyzing step additionally comprises elucidating at least one medical term appeared at the at least one medical document, at least one drug, at least one treatment and the same.

The method as described above, wherein the analyzing step is additionally configured to analyze the effect of at least one drug on segmented users.

The method as described above, wherein the analyzing step is additionally configured to show possible diagnosis based on symptoms, test results and the self-generated data.

The method as described above, wherein the step of establishing at least one support group is additionally is configured to connect a first client to a second client of the same age with the same medical condition.

The method as described above, wherein the analyzing step is additionally configured to present medical information to at least one client selected from the group consisting of treatments, medications, surgeries, alternative medicine methods, alternative uses for the user's medications, report head-to-head drugs, analysis of the effect of a specific medication on a particular group of users.

The method as described above, wherein the analyzing step is additionally configured to provide the user with a possible diagnosis based on the user's medical information the user inserted in the file.

The method as described above, wherein the analyzing step is additionally configured to analyze the user's social networks in order to detect specific medical conditions that prevail in the user's closest family or among the user's friends.

The method as described above, wherein the method additionally comprises connecting the client with at least one physician.

The method as described above, wherein the method additionally comprises suggesting the client at least one relevant clinical trial.

The method as described above, wherein the method additionally comprises bill tracking.

The method as described above, wherein the method additionally comprises White-label service.

The method as described above, wherein the health file is additionally configured to be two-way synced.

The method as described above, wherein the method is configured to allow at least one client to manage a plurality of health files.

The method as described above, wherein the method configured to serve as a clinical trial management platform for the clinical trials companies helping them to reach potential participants.

The method as described above, wherein the method is configured to generate a personalized health report for the user.

The method of as described above, wherein the method additionally allows to an interested party retrieve statistical information.

The method as described above, wherein the method is configured to sync the file between the computing devices.

The method as described above, wherein the system comprises the following modules: i) at least one application server, ii) at least one optical character recognition server, iii) at least one search index server, iv) at least one document-oriented database system, v) at least one storage service, vi) at least one statistical storage and analysis server.

The method as described above, wherein the method is configured to store the user's file on the user's computing device and on a system's database server.

The method as described above, wherein the modules are configured to have secured communication.

The method as described above, wherein the system is configured to use the data mining process.

The method as described above, wherein the system is configured to store at least one health file in the database storage server for backup.

The method as described above, wherein the system is configured to be two-way synced between the computing devices.

The method as described above, wherein the system is configured to allow at least one client to restore any deleted medical document.

The method as described above, wherein the application server is configured to manage the actions selected from the group consisting of creating a new account of a health file, signing in existing clients, managing a user session and an application session.

The method as described above, wherein the application server is additionally configured to store the client's medical documents and the medical documents' metadata.

The method as described above, wherein the application server is additionally configured to transfer the medical documents to the OCR servers.

The method as described above, wherein the application server is additionally configured to perform statistical data analysis and store statistical analysis on the statistical storage server.

The method as described above, wherein the application server is additionally configured to perform auditing on all requests sent to the server and configured to check automatically for security threats.

The method as described above, wherein the method is configured to go through thought heavy security tests selected from the group consisting of web application security scanning, vulnerability scanning, penetration testing and static source code analysis.

The method as described above, wherein the application server is additionally configured to run behind a firewall.

The method as described above, wherein all the communication routes between the modules and between the modules and the computing device are configured to be encrypted according to HIPAA and HITECH Act standards.

The method as described above, wherein all data saved on the servers are configured to be encrypted according to HIPAA and HITECH Act standards.

The method as described above, wherein the application server is additionally configured to test encryptions by using password cracking tools known in the art.

The method as described above, wherein the OCR server is configured to can analyze its input and can perform different operations and manipulations according to the state of the input in order to obtain the best OCR results.

The method as described above, wherein the health files storage server is configured the encrypted clients' medical documents.

The method as described above, wherein the database server is configured to keep information about the clients, the metadata and analysis results from the OCR server.

The method as described above, wherein the statistical storage and analysis server is configured to perform statistical analysis within the user's file and store the results of the analysis.

The method as described above, wherein the statistical storage and analysis server is configured to retrieve and store unidentified information from the application server and OCR server.

The method as described above, wherein the statistical storage and analysis server is configured to process and aggregate the information upon demand.

The method as described above, wherein the method is configured to store the user's file on the user's computing device and on the database server for backup.

### BRIEF DESCRIPTION OF FIGURES OF THE PRESENT INVENTION

FIG. 1 illustrates the flow chart of the method of the present invention.

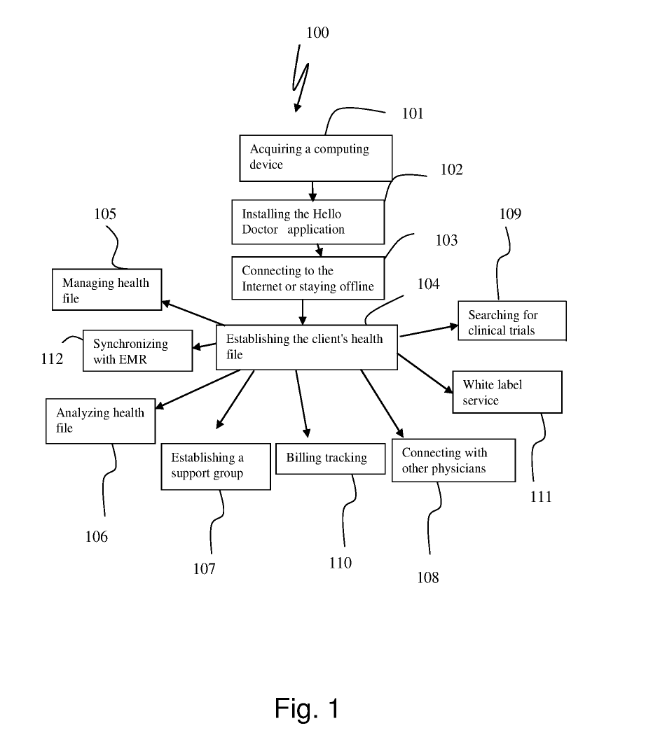

FIG. 2 illustrates the flow Mart of the establishing step of the user's health file.

FIG. 3 illustrates the flow chart of the system of the present invention.

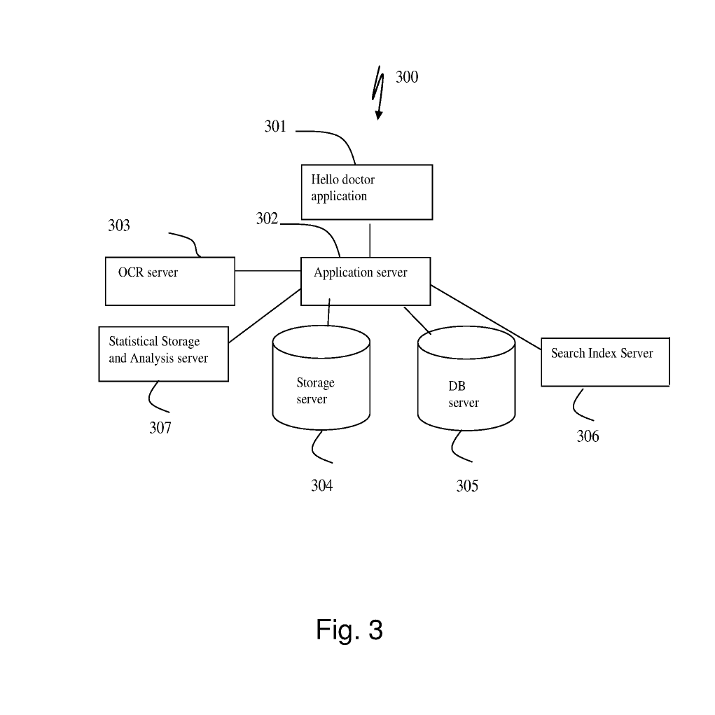

FIG. 4 illustrates the screen shot of the Hello Heart application according to a preferred embodiment of the present invention, showing blood pressure reading placed on a graph as a visual aid to help users understand their medical information.

FIG. 5 illustrates the screen shots of the Hello Heart application according to a preferred embodiment of the present invention, showing the patient's medical records and personalized explanations according to the patient's medical condition and risks, using color-coded scales.

FIG. 6 illustrates the screen shots of Hello Heart applications according to a preferred embodiment of the present invention, showing usage of graphs, scales, and smiley faces to simplify the explanations and data, making the medical records easy to understand.

FIG. 7 illustrates the screen shots of Hello Heart applications according to a preferred embodiment of the present invention, showing medical records scattered among several health systems are organized in a simple list menu easily accessible on the user's mobile device.

### DETAILED DESCRIPTION OF THE PRESENT INVENTION

The following description is provided so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide product and method of the invention described herein.

Medical records are scattered among various health systems and sources. Often people don't understand their medical records—the present invention analyzes data and provides personalized explanations according to the patient's medical condition and risks. The data is presented in the form of graphs and visual aids (such as smiley faces) to provide simplified and readily comprehensible explanations and data. As a consequence the invention leads to increased compliance with health recommendations and beneficial lifestyle behaviors.

The present invention provides methods and means to enable people to access their medical records in a user friendly format on their mobile devices, Embodiments of the present invention enable these records to be accessed in 2 taps.

In the following description the terms user/client are used interchangeably, additionally the terms document/record are also used interchangeably. Furthermore the terms physician/clinician/specialist are used interchangeably.

It is herein acknowledged that an embodiment of the present invention is a computing device-implemented method (100) for managing health file. The method comprises steps of:
i. acquiring at least one computing device (101);
ii. installing Hello Doctor application (102);
iii. establishing a client's health file (104);
iv managing the client's the health file (105);
v. analyzing the client's the health file (106).

In other embodiments of the present invention the method incorporates the step of establishing support groups (107) by Hello Doctor users based on the age, medical condition, gender, geographical location or any other demographic feature.

Any embodiment of the Hello Doctor application can be installed (102) on any computing device selected from the group consisting of mobile phone, smartphone, tablet computer, wearable computer, calculator watch, smartwatch, head-mounted display, personal digital assistant, enterprise digital assistant, calculator, handheld game console, portable media player, ultra-mobile PC, digital still camera (DSC), digital video camera (DVC), digital camcorder, feature phone, pager, personal navigation device, desktop computer, laptop computer.

The user can connect (103) to the application server via internet or intranet by means selected from the group consisting of LAN, broadband access, multilink dial-up, ISDN, leased lines, cable internet access, digital subscriber line (DSL, ADSL, SDSL, and VDSL), DSL Rings, fiber to home, power-line internet, ATM and Frame Relay, Wi-Fi, Wireless ISP, WiMAX, satellite broadband, mobile broadband, local multipoint distribution service and any other known in the art technologies. The application also implements GUI. The embodiments of the present invention are configured to be executed in both online and offline modes and represent a real-time tool.

The embodiments of the present invention can store the health file on the user's computing device, thus the embodiments of the present invention can be implemented offline (103) when the user's computing device is not connected to the Internet. However, once the user connects the computing device to the internet the embodiments of the present invention are synced with the cloud and the client's health file is updated.

### Establishing a Client's Health File (200)

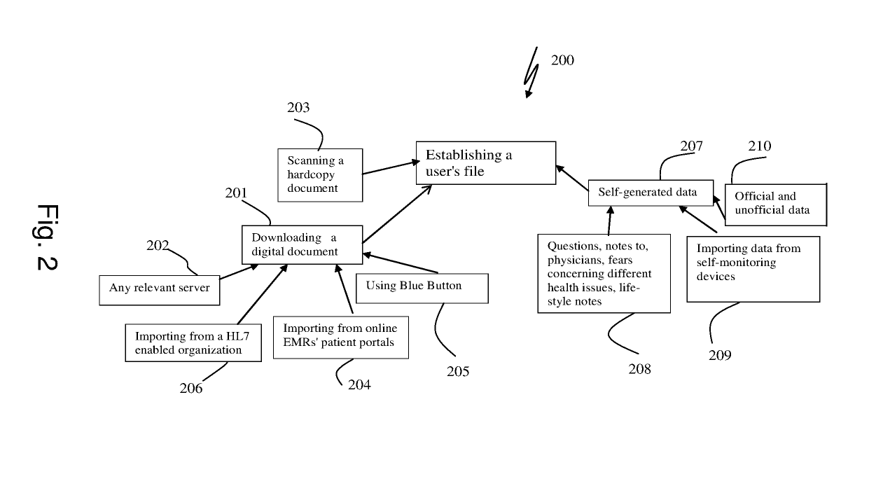

Now the reference is made to FIG. 2 which illustrates the flow chart of establishing a client's health file step. This step comprises various features. When a client registers as a new user he can start importing his medical documents by different ways. The client can download any electronic medical document (201) such as test results from a relevant server (202); the client can upload medical imaging files selected from the group consisting of X-ray, MRI, fluoroscopy, scintigraphy, SPECT, PET, CT-PET, PET/MRI, ultra-sound, tactile imaging, photoacoustic imaging, thermography, tomography, echocardiography. Additionally the client can scan (203) a hard copy document with a scanning device or otherwise use a digital camera or a camera application on the computing device to photograph the document. In some embodiments of the present invention the document image may be sent by the application to the OCR server and stored in the health record database as a text file. This step includes text recognition configured to determine a type and a date of the document. Additionally the step includes document edge detection. In other embodiment of the present invention the document's image can be stored as it is without conversion in to a text file.

The users can import record from online EMRs' Patient Portals (204), use Blue Button (205), from HL7 enabled organizations (206). The client can also input self-generated data (207). The user can add their own notes, questions to their physicians, fears they have concerning treatment options, diagnosis, medications' doses and side effects, etc. (208). Users can choose to import data from self-monitoring devices (209) such as a heart rate monitor watch, pedometer, glucometer, sphygmometer. The user can input information regarding the drugs he/she uses and treatments he/she receives.

Furthermore, the user can input self-generated data comprises data from official records and unofficial records (210), Wong Baker pain scale data, Numeric Rating Scale, ECOG/WHO/Zubrod score, Karnofsky scale, Apgar scale for newborns and any other conventional scale.

The client can add information regarding the lifestyle represented in non-limiting way by nutritional habits, sleeping hours, sleeping patterns, type of physical exercise the user practices, stressful situations the user goes through, substance abuse (cigarettes, alcohol, recreation drugs or any other legal or illegal mind conditioning chemical or herbal formulations). Furthermore the self-generated data may include a psychological state of the user, medications adherence, treatments adherence, any periodic behavioral pattern adherence, status of bodily physiological functions and any other data that the user finds important. The method for monitoring an adherence will be elaborated later in the description.

When the client adds a document, every document is tagged with Record Type and Date Created for easy management and navigation through the documents. The user can tag at least one document himself; the user can send at least one document to Hello Doctor application server for automatic tagging, furthermore the user can apply automatic tagging using OCR and other methods, scan a designated QR Code (or any other visual code) printed on every document, which contains the Record Type and Record Date information for auto tagging while taking a photo of the document.

User can add more than one page per record. The user can get notifications as reminders to keep their medical file up-to-date; these notifications can be triggered by location (when leaving the doctor's office, for example), by time (half an hour after an appointment with the doctor), by a recurring reminder. The notification can be in the form of an e-mail, SMS, a sound effect, a popping window.

### Managing Step (105).

The application allows the client to view the health file in a chronological order. Every medical record is tagged with Record Type and Record Date for easy navigation within the user's health file. The application implements a SmartList navigation method. SmartList is a list of all records by Record Type. In the embodiments of the present invention the user can access any record by Type, when asked to show a specific record type by the doctor. Every SmartList has its own color, and the Hello Doctor application uses this color code throughout its interface, for easy navigation. In some embodiments of the present invention SmartList may implement color code that is suitable for a user with an impaired color vision. In other embodiments of the present invention the user can design his/her own color code. The user can reach any Smart List by either using the application navigation menu, or by dragging a record upwards while in chronological view. In addition to the SmartList navigating method the Hello doctor application implements allow the user to search through the file by means selected from the group consisting of a text-based search engine and implementing timestamps. The embodiments of the present invention allow the user to use keywords such as record type name, day/month/year (as text), a doctor's name, a drug's name, a hospital's name, etc.

The managing step is additionally configured to share the health file by means selected from the group consisting of e-mail, a mobile ad hoc network, wireless ad hoc network, electronic patient record, exporting to online cloud storage, fax, sharing direct link, using Direct, copying to the computing device's clipboard.

The embodiments of the present invention also implement a diary management. The user can put all their upcoming appointments, tests on a calendar, furthermore the user can create a to-do list within the application including scheduling, phone calls, reminders, billing, etc., including the ability to assign a to-do to another person. Additionally the user can get reminders by means of popping windows, sound alarm, e-mailing, SMS sending. The user can also monitor a medication's adherence by inserting an administering schedule of a specific drug through the diary management and the application can remind according to the schedule to take, inject or inhale the medication. When the user gets a reminder from the application and takes the medication and can input a note. Thus by this non-limiting example the embodiments of the present invention can monitor not only specific drug's adherence but also sport activity adherence, measuring physiological parameter adherence (for example measuring blood pressure or measuring blood sugar). Thus the application can create an adherence report of any desirable behavioral pattern.

Additionally application enables the user to add a question or a comment to the specific document relating to the content of the document. For example by non-limiting way the user can put a question about a drug on a prescription; or the user can put a question about the same drug on the drug's leaflet.

The user can create a data report represented by management charts. In some embodiments of the present invention the application can automatically generate a timeline chart for the user. In other embodiments of the present invention the user can create timeline charts manually.

The embodiments of the present invention also enables the user to create a customized view for test results and other medical records in addition to the original medical record in order to better understand, focus and explain medical records. This can be implemented by using infographics, graphs, charts, flowcharts, tables and other information presentation methods.

### Analyzing Step (106).

The embodiments of the Hello Doctor application can provide the user with a dashboard with all the official medical documents, self-generated data, and critical medical data to show their doctor (for example: abnormal test results, such as high white blood cells count). Additionally the embodiments of the present invention can make a statistical analysis of items inserted as the self-generated and present them as grouped data (frequency distribution). For example, a diabetic user measures the blood glucose level several times a day before and after a meal and inserts these measurements into the health file. The application can present the user the frequency distribution of the glucose levels over any time period the user wishes to know. The same analysis can be performed on any self-generated data.

The embodiments of the present invention can suggest relevant, based on the user's medical condition and history, a user's demographics, a user's financial status, recent medical researches and articles, and supply easy access to them. Furthermore, the application can highlight relevant and important information from these researches and articles in an everyday language. The application can show the user what other patients chose being in the same condition and demographic group (age, medical history, financial status, geographic location, gender) to do when the user has to make a critical decision(“90% of female patients with breast cancer, aged 25-35, near you went through a surgery; other 10% went through a chemotherapy).

The embodiments of the present invention can provide information about treatments, medications, surgeries, alternative medicine methods etc.; find alternative uses for medications, report head-to-head drugs, analyze the effect of a specific medication on a particular group of users. Furthermore the embodiments of the present invention can analyze the user's social networks (family, friends) in order to detect specific medical conditions that prevail in the user's closest family or among user's friends. The embodiments of the present invention can provide the user with a possible diagnosis based on the medical information (test results, symptoms) the user inputs into the health file.

The application allows different users to be part of a support group based on a gender, age, medical condition, geographic location, demographics and financial status.

### Additional Features.

The method can also connect users with physicians (108): the application comprises rated clinicians' index, where the users can search for specific specialists. The user can send the medical documents to the specialists directly from the Hello Doctor application and receive a quick response directly to the application, with a notification.

The application can also suggest relevant clinical trials (109) according to the user's medical history, stage, age, gender, previous treatments, etc.

Some embodiments of the present invention can serve as a clinical trial management platform for the clinical trials companies helping them to reach potential participants.

The application also allows billing tracking (110): making sure the medical bills fit actual medical tests and treatments done, suggesting financial options: loans, better insurance plans, etc. Some other embodiments of the present invention can be served as a completely branded white label (111) for other companies.

The application enables the user to create a personalized health report. Additionally customers such as pharmaceutical companies, universities, hospitals, national institutes, insurance companies and any other health related public organization can retrieve specific statistical data for a certain fee.

Furthermore, medical institutions such as hospitals, clinics and others can choose to use the embodiments of the present invention in order to fully synchronize (112) their own EMR (Electronic Medical Records) Patient Portal with the embodiments of the present invention installed on the user's computing device. Thus the users can gain real time access to their medical records stored in medical institutions database system. In this case the embodiments of the present invention allow the medical institution full accesses to the user's EMR (including editing); on the other hand the user gains only view mode accesses. As it is known EMRs provide their users with a username and password. The user can provide some of the embodiments of the present invention with the ERMs' username and password and the embodiments of the present invention can retrieve the patient's data and sync with the system's database server which will be elaborated further and the user's computing device.

Moreover, the user's medical file is stored in the system's database server for a backup, and can be synced between the computing devices. The user can manage more than one medical file. For instance, Jessica can manage her own medical file, her 2 kids' medical files, and her parents' medical files. Alexander and David can both manage (or view only) their mother's medical file, as Alexander is the main caregiver, and David lives in a different country but stays up-to-date for any case. The user can restore any deleted medical record

### The System (300).

When a client starts up Hello Doctor application (301) he can be connected to the application server (302). On the other hand the user can choose to work with the application in an offline mode. All the data stored within the system and all communication routes between different modules are encrypted according to HIPAA (The Health Insurance Portability and Accountability Act) and HITECH Act (Health Information Technology for Economic and Clinical Health) standards. The system is configured to use the data mining process.

The system comprises the following modules:
i. at least one application server (302);
ii. at least one OCR (optical character recognition) server (303);
iii. at least one search index server (306);
iv. at least one document-oriented database server (305);
v. at least one storage server (304);
vi. at least one statistical storage and analysis server (307).

### Application Server (302)

The cloud computing of the application server can be provided by any web service known in the art that provides resizable compute capacity in the cloud. The application server can be based on a web-based scalable framework known in the art. The application servers can manage by non-limiting way the following actions: creating a new account of a health file, signing in existing clients, managing a user session and an application session. Additionally the application server can store a client's medical documents, medical documents metadata, transfer the documents to OCR servers (303), perform statistical data analysis and store statistical analysis on the statistical storage server. Furthermore, the application server performs auditing on all requests sent to it and checks automatically for security threats. Additionally the server goes thought heavy security tests selected from the group consisting of web application security scanning, vulnerability scanning, penetration testing and static source code analysis. All encryptions are tested using password cracking tools known in the art and the server runs behind a firewall.

### OCR Server (303)

The OCR server of the embodiments of the present invention can implement tasseract OCR engine. This server can receive image files of the medical documents obtained by scanning or photographing hardcopy documents and return text files. The OCR server can analyze its input and can perform different operations and manipulations according to the state of the input in order to obtain the best OCR results.

### Health Files Storage Server (304)

This server can hold all encrypted clients medical documents. The preferred embodiment can implement the Amazon S3 service as the storage server.

### Database Server (305)

This server can implement MongoDB as a document-oriented database system that enables saving files in the Document format. This server can keep information about clients, file metadata, and analysis results from OCR server. The database server can implement NoSql technology.

### Search Index Server (306)

This server can implement ElasticSearch software and enables clients to perform search within their health files. Furthermore, the search server can run an information retrieval software library such as Lucene. The search server can obtain files from the OCR server.

### Statistical Storage and Analysis Server (307)

This sever can perform statistical analysis within a client's medical file and store the results. This server will save unidentified information retrieved from the Application and OCR servers, the information will be processed and aggregated by demand and need. This server can be based on Hadoop framework.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

### The Hello Heart Application

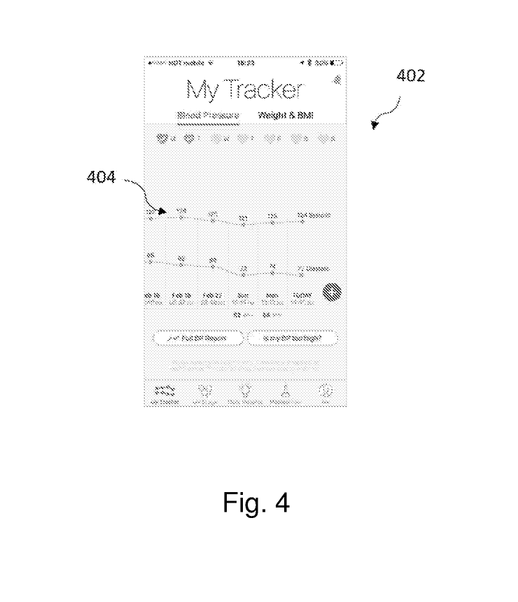

Another embodiment of the present invention directed towards medical data related to heart conditions is named Hello Heart application for differentiation. Reference is now made to FIG. 4, which presents the screen shot (402) of the Hello Heart application according to a preferred embodiment of the present invention, showing blood pressure reading placed on a graph (404) as a visual aid to help users understand their medical information.

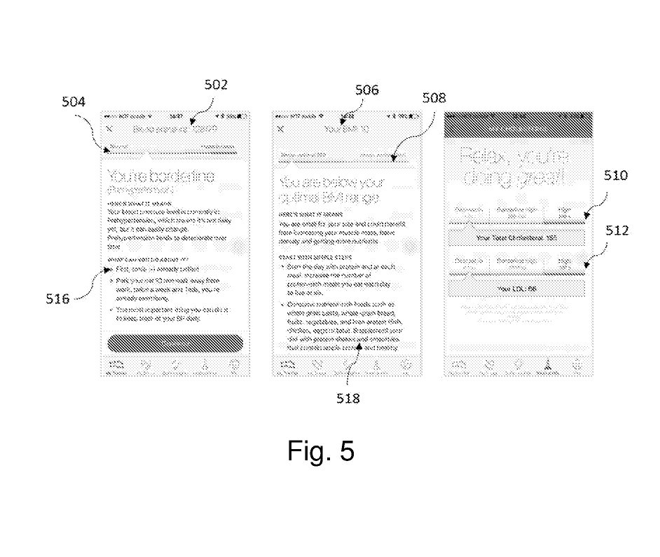

Reference is now made to FIG. 5, which presents the screen shots of the Hello Heart application according to a preferred embodiment of the present invention, showing the patient's medical records and personalized explanations according to the patient's medical condition and risks, using color-coded scales. The Hello Heart application analyzes medical records and provide personalized explanations according to the patient's medical condition and risks, using color-coded scales. According to a preferred embodiment, blood pressure reading (502) is placed on a color-coded scale (504) going from “Normal” to “Hypertension”, accompanied by personalized explanation (516). According to another preferred embodiment, BMI result (504) is placed on a color-coded (508) scale going from “Below optimal BMI” to “Above optimal BMI”, accompanied by personalized explanation (518). According to another preferred embodiment, total cholesterol level and LDL level is shown on color-coded scales (510 and 512).

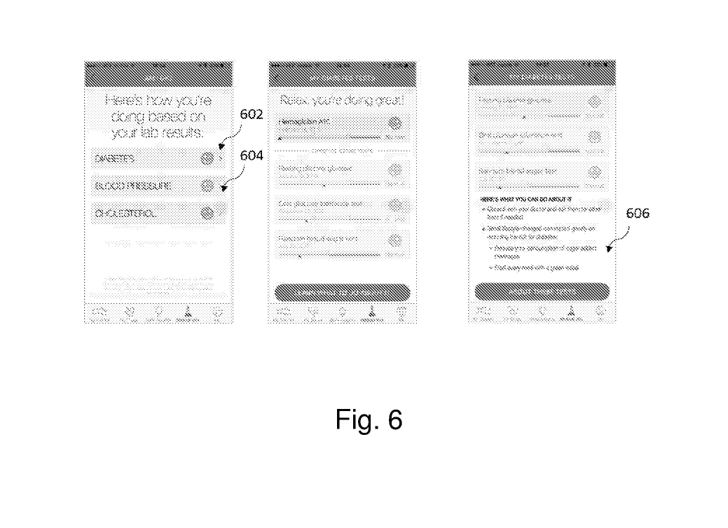

Reference is now made to FIG. 6, which presents the screen shots of Hello Heart applications according to a preferred embodiment of the present invention, showing usage of graphs, scales, and smiley faces to simplify the explanations and data, making the medical records easy to understand. The Hello Heart application analyzes medical records and provide personalized explanations according to the patient's medical condition and risks, using color-coded smiley faces. The Hello Heart application uses graphs, scales, and smiley faces to simplify the explanations and data, making the medical records easy to understand. According to some preferred embodiments, green smiley face (602) indicates good results while yellow unhappy face (604) indicates the results are not so good. According to a preferred embodiment, personalized explanation of medical test (such as diabetes test, blood pressure test, cholesterol test et al) results (606) is provided.

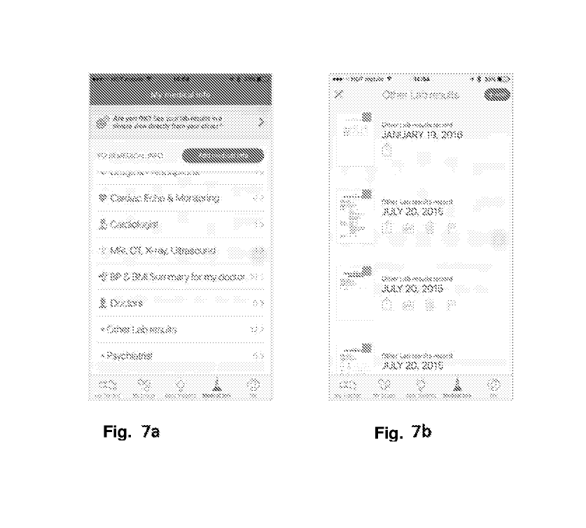

Reference is now made to FIG. 7, which presents the screen shots of the Hello Heart applications according to a preferred embodiment of the present invention, showing medical records scattered among several health systems are organized in a simple list menu easily accessible on the user's mobile device. According to a preferred embodiment, the Hello Heart application takes medical records scattered among several different health systems (cardiologist, psychiatrist, radiologist et al), and organizes them in a simple list menu accessible on the user's mobile device as shown in FIG. 7a. According to another embodiment, the Hello Heart application organizes medical records by record type and date, making each record easily accessible in just 2 taps a shown in FIG. 7b.

1-88. (canceled)

89. A computing device-implemented method for managing medical health record comprising the steps of:
i. acquiring at least one computing device;
ii. installing an application implementing said method;
iii. establishing a client's health file;
iv. managing said client's said health file;
v. analyzing said client's said health file;
vi. establishing at least one support group;
wherein said step of establishing said client's said health file comprises means selected from the group consisting of inputting at least one medical digital document, inputting a digital copy of at least one hardcopy medical document.

90. The method of claim 89, wherein said step of establishing a health file additionally comprises uploading at least one medical imaging document selected from the group consisting of X-ray, MRI, fluoroscopy, scintigraphy, SPECT, PET, CT-PET, PET/MRI, ultra-sound, tactile imaging, photoacoustic imaging, thermography, tomography, echocardiography.

91. The method of claim 89, wherein said method additionally configured to be implemented offline.

92. The method of claim 89, wherein said step of establishing a health file includes configuring said computing device to use a camera application for importing said digital copy of said hardcopy medical document.

93. The method of claim 89, wherein said establishing step of a health file is configured to use a scanning device for importing said digital copy of said at least one hardcopy medical document.

94. The method of claim 89, wherein said establishing step additionally comprises using Blue Button.

95. The method of claim 89, wherein said managing step additionally comprises diary managing.

96. The method of claim 95, wherein said diary managing additionally comprises reminding means configured to be selected from the group consisting of popping windows, sound alarm, e-mailing, sending an SMS.

97. The method of claim 95, wherein said diary managing additionally comprises monitoring at least one periodic behavioral pattern adherence and wherein said diary managing is configured to create at least one adherent report of said pattern.

98. The method of claim 89, wherein said method additionally comprises a Smartlist document navigation method.

99. The method of claim 89, wherein said method additionally comprises White-label service.

100. The method of claim 89, wherein said health file is additionally configured to be two-way synced.

101. The method of claim 100, wherein said method is configured to sync said file between said computing devices.

102. The method of claim 100, wherein said method is configured to store said at least one health file in the cloud for backup.

103. The method of claim 89, wherein said computing device is selected from the group consisting of mobile phone, smartphone, tablet computer, wearable computer, calculator watch, smartwatch, head-mounted display, personal digital assistant, enterprise digital assistant, calculator, handheld game console, portable media player, ultra-mobile PC, digital still camera (DSC), digital video camera (DVC), digital camcorder, feature phone, pager, personal navigation device, desktop computer, laptop computer.

104. The method of claim 89, wherein said managing step can be implemented in 2 taps on said computing device.

105. The method of claim 89, wherein the method additionally comprises displaying data on a graphical user interface (GUI) of said device.

106. The method of claim 105, wherein the method comprises displaying data on a graphical user interface (GUI) of said device including personalized explanations according to the patient's medical condition and risks.

107. The method of claim 89, further comprising a step of displaying medical information as a graph, a color-coded scale, a visual aid or any combination thereof.

108. The method of claim 89, further comprising a step of collecting medical records scattered among several health systems and organizing said medical records into a simple list menu on said at least one computing device.
